(19) United States
(12) Patent Application Publication
(10) Pub. No.: US 2013/0087417 A1
(43) Pub. Date: Apr. 11, 2013

(54) ELECTRONIC DISC BRAKE

(71) Applicant: MANDO CORPORATION, Gyeonggi-do (KR)

(72) Inventors: Sung Wook YU, Seoul (KR); Chang Bok KO, Gyunggi-do (KR); Young Song LEE, Gyeonggi-do (KR)

(73) Assignee: MANDO CORPORATION, Gyeonggi-do (KR)

(21) Appl. No.: 13/648,055

(22) Filed: Oct. 9, 2012

(30) Foreign Application Priority Data
Oct. 10, 2011 (KR) 10-2011-0102791

(51) Int. Cl. B60T 1/06

(52) U.S. Cl. 188/72.3

(57) ABSTRACT

Disclosed herein is an electronic disc brake in which driving force of a motor may be transmitted to a gear unit in a serial manner. The electronic disc brake which has a carrier, a caliper housing, a pair of pad plates disposed at both sides of a disc, and a piston installed within a cylinder part and pressing one of the pair of pad plates toward the disc, includes a spindle member passing through the rear wall of the caliper housing and rotated within the cylinder part, a nut member screw-connected to the spindle member and pressing the piston or releasing pressing of the piston, a motor generating driving force, and a cycloid reducer amplifying the driving force generated from the motor and transmitting the amplified driving force to the spindle member, and the motor, the cycloid reducer and the spindle member are coaxially connected in series.

### CROSS-REFERENCE TO RELATED APPLICATION

This application claims the benefit of Korean Patent Application No. 2011-0102791, filed on Oct. 10, 2011 in the Korean Intellectual Property Office, the disclosure of which is incorporated herein by reference.

### BACKGROUND

1. Field

Embodiments of the present invention relate to an electronic disc brake having a parking function in which driving force of a motor may be transmitted to a gear unit in a serial manner.

2. Description of the Related Art

In general, a parking brake device stops a vehicle if it is desired to park the vehicle, and serves to hold a wheel of the vehicle so as not to rotate.

Recently, an electronic parking brake (EPB) system, driving of which is electronically controlled, is used, and such an EPB system is mounted on a conventional disc brake and performs the function of the parking brake. Here, EPB systems are divided into a cable puller type, a motor-on-caliper type and a hydraulic parking brake type.

FIG. 1 is a cross-sectional view illustrating a conventional electronic disc brake. The electronic disc brake shown in FIG. 1 is of a motor-on-caliper type.

With reference to FIG. 1, the electronic disc brake 1 includes a disc D rotating together with a wheel (not shown) of a vehicle, a carrier 10 provided with a pair of pad plates 11 and 12 disposed at both sides of the disc D to press the disc D, a caliper housing 20 installed on the carrier 10 so as to be slidable and provided with a piston 21 installed therein and moving forward and backward to press the pair of pad plates 11 and 12, a motor 60 generating driving force, a reducer 40 amplifying the driving force generated from the motor 60, a gear assembly 50 transmitting the driving force of the motor 60 to the reducer 40, and a spindle unit 30 transmitting rotating force of the motor 60 from the reducer 40 to the piston 21.

The pair of pad plates 11 and 12 includes an inner pad plate 11 adjacent to the piston 21 and an outer pad plate 12 located at the opposite side of the inner pad plate 11.

A cylinder 23 is provided at one side of the caliper housing 20, and the piston 21 pressing the inner pad plate 11 toward the disc D is installed in the cylinder 23. A finger part 22 bending downward and integrally connected to the cylinder 23 is provided at the other side of the caliper housing 20, and presses the outer pad plate 12 to the disc D together with sliding of the caliper housing 20.

The carrier 10 is fixed to a vehicle frame and guides the pair of pad plates 11 and 12 so as to move forward and backward toward or away from or away from the disc D without separation of the pair of pad plates 11 and 12.

The piston 21 rectilinearly reciprocates through driving of the motor 60 and presses the inner pad plate 11 toward the disc D during braking operation. Driving force of the motor 60 is transmitted to the reducer 40 through the gear assembly 50, is amplified by the reducer 40, and is then transmitted to the piston 21 through the spindle unit 30.

The spindle unit 30 serves to press the piston 21 toward the inner pad plate 11, as described above. Such a spindle unit 30 includes a spindle member 35 screw-connected to a rotary shaft of a carrier 47 of the reducer 40 which will be described later and receiving rotating force of the motor 60, and a nut member 31 screw-connected to the spindle member 35 and pressing the piston 21. A bearing 25 to support the spindle member 35 is installed within the cylinder 23.

The gear assembly 50 includes a driving gear 51 installed on a shaft 61 of the motor 60, a driven gear 54 connected to the reducer 40, and a pinion idle gear 52 connecting the driving gear 51 and the driven gear 54. That is, driving force generated through rotation of the shaft 61 of the motor 60 is transmitted to the driven gear 54 through the pinion idle gear 52 engaged between the driving gear 51 and the driven gear 54.

The reducer 40 is formed of a 2-stage planetary gear type. That is, the reducer 40 includes a first reduction unit, a second reduction unit and an internal gear 44.

The first reduction unit includes a first sun gear 41 installed at a central shaft 53 of the driven gear 54, a plurality of first planet gears 42 disposed around the first sun gear 41 so as to be engaged with the first sun gear 41, and a first carrier 43 connected to shafts 42a of the first planet gears 42.

The second reduction unit has the same structure as the first reduction unit. That is, the second reduction unit includes a second sun gear 45 installed at a rotary shaft of the first carrier 43, a plurality of second planet gears 46 disposed around the second sun gear 45 so as to be engaged with the second sun gear 45, and a second carrier 47 connected to shafts 46a of the second planet gears 46, and a rotary shaft of the second carrier 47 is connected to the spindle unit 30. Here, the first and second planet gears 42 and 46 are engaged with the internal gear 44 fixed at the outside of the first and second planet gears 42 and 46.

That is, in the above-described electronic disc brake 1, driving force generated by operation of the motor 60 is transmitted to the reducer 40 through the gear assembly 50, and when the first sun gear 41 is rotated, the first planet gears 42 engaged to the fixed internal gear 44 are revolved and revolution of the first planet gears 42 is transmitted to the second reduction unit through the first carrier 43. Further, the second reduction unit transmits rotating force to the spindle member 35 through the same action as the first reduction unit, thereby allowing the spindle member 35 to be rotated at a reduced speed. When the spindle member 35 is rotated, the nut member 31 moves in the axial direction and presses the piston 21, thereby performing braking.

However, since the above-described electronic disc brake 1 is formed in a structure in which driving force of the motor 60 is firstly reduced through the gear assembly 50, is secondarily reduced through the reducer 40 formed in the 2-stage planetary gear type, and is then converted into rectilinear force by the spindle unit 30 to generate braking force, i.e., a U-type power transmission structure, if the electronic disc brake 1 is mounted, the sizes of the cylinder 23, the carrier 10 and a power transmission unit (the motor, the gear assembly and the reducer) are increased, and thus the electronic the disc brake 1 may be only installed on vehicles of a medium size or more.

Further, the electronic disc brake 1 may be disadvantageous in terms of operating noise during braking by means of the gears configured in a multiple stage structure.

Therefore, various research and development to improve utilization of a space for installation of an electronic disc brake operated using a motor or to reduce operating noise of the electronic disc brake have been carried out.

### SUMMARY

Therefore, it is an aspect of the present invention to provide an electronic disc brake which has a reduced volume, reduces operating noise, and is efficiently operated by improving structures of respective parts including a motor generating driving force, gears transmitting the driving force and a reducer reducing rotating force, and a connection structure between the parts.

Additional aspects of the invention will be set forth in part in the description which follows and, in part, will be obvious from the description, or may be learned by practice of the invention.

In accordance with one aspect of the present invention, an electronic disc brake which has a carrier fixed to a frame of a vehicle, a caliper housing installed on the carrier so as to be slidable, a pair of pad plates installed within the carrier so as to be forwardly and backwardly movable and disposed at both sides of a disc rotating together with a wheel of the vehicle, and a piston installed within a cylinder part provided on the caliper housing so as to be forwardly and backwardly movable and pressing one of the pair of pad plates toward the disc, includes a spindle member passing through the rear wall of the caliper housing and rotated within the cylinder part, a nut member screw-connected to the spindle member and moving forward and backward according to rotation of the spindle member to press the piston or to release pressing of the piston, a motor installed on the outer surface of the caliper housing and generating driving force to rotate the spindle member, and a cycloid reducer amplifying the driving force generated from the motor and transmitting the amplified driving force to the spindle member, wherein the motor, the cycloid reducer and the spindle member are coaxially connected in series.

The motor may be a thin motor, and the motor and the cycloid reducer may be accommodated in a motor cover housing and be installed on the rear wall of the caliper housing.

The cycloid reducer may include an eccentric rotator connected to a rotary shaft of the motor and eccentrically transmitting rotation of the motor, a cycloid gear provided with a plurality of through holes disposed in a radial direction from the center thereof and eccentrically rotated by the eccentric rotator, the eccentric rotator being installed at the center of the cycloid gear, an internal gear engaged with the outer surface of the cycloid gear and revolving and rotating the cycloid gear by rotation of the rotary shaft, and pins respectively inserted into the plurality of through holes and compensating for the eccentric center of the cycloid gear.

The internal gear may be fixed to the motor so as not to be rotated.

Bearings may be installed between the cycloid gear and the eccentric rotator.

The electronic disc brake may further include an output shaft connected with the pins and transmitting rotating force to the spindle member, the output shaft may include a shaft part screw-connected to the spindle member having passed through the rear wall of the caliper housing and a flange part protruded from the end of the shaft in the radial direction, and insertion holes may be formed on the flange part at positions corresponding to the plurality of through holes, and connected with the pins.

The spindle member may include a spindle shaft having a designated length and provided with a male screw part screw-connected to the nut member and formed on the outer circumferential surface of one end of the spindle shaft, and a flange part protruded from the other end of the spindle shaft in the radial direction, and insertion holes may be formed on the flange part at positions corresponding to the plurality of through holes and be connected with the pins.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view illustrating a conventional electronic disc brake;

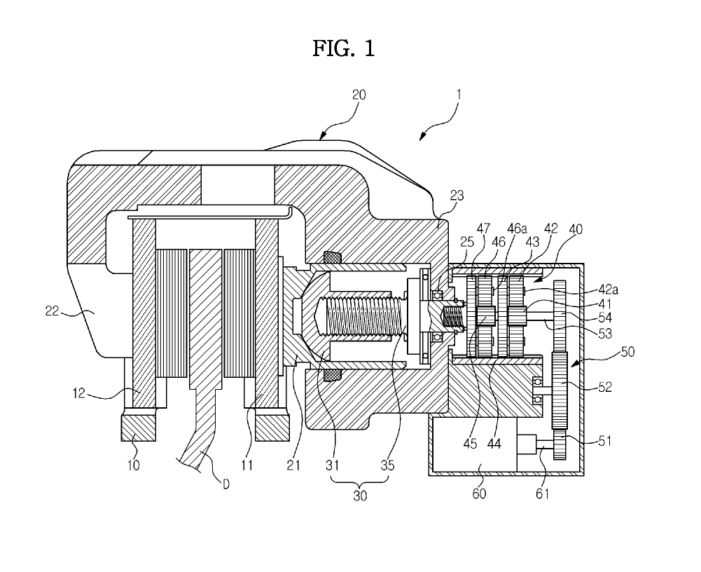

FIG. 2 is a cross-sectional view illustrating an electronic disc brake in accordance with one embodiment of the present invention;

FIG. 3 is an exploded perspective view illustrating an actuator provided on the electronic disc brake in accordance with the embodiment of the present invention;

FIG. 4 is a front view illustrating a cycloid reducer provided on the electronic disc brake in accordance with the embodiment of the present invention;

FIG. 5 is a cross-sectional view of FIG. 3 in an assembled state;

FIG. 6 is a cross-sectional view illustrating an electronic disc brake in accordance with another embodiment of the present invention; and

FIG. 7 is a partially enlarged view illustrating a motor, a cycloid reducer and a spindle member provided on the electronic disc brake of FIG. 6.

### DETAILED DESCRIPTION

Reference will now be made in detail to the embodiments of the present invention, examples of which are illustrated in the accompanying drawings, wherein like reference numerals refer to like elements throughout. The terms used in the following description are terms defined taking into consideration the functions obtained in accordance with the embodiments, and the definitions of these terms should be determined based on the overall content of this specification. Therefore, the configurations disclosed in the embodiments and the drawings of the present invention are only exemplary and do not include all of the technical spirit of the invention, and thus it will be appreciated that the embodiments may be variously modified and changed.

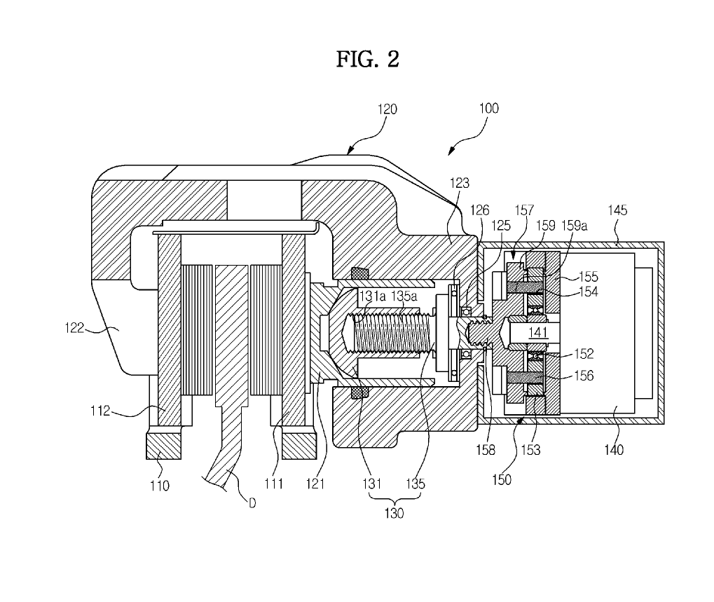

FIG. 2 is a cross-sectional view illustrating an electronic disc brake in accordance with one embodiment of the present invention.

With reference to FIG. 2, the electronic disc brake 100 includes a disc D rotating together with a wheel (not shown) of a vehicle, a carrier 110 provided with a pair of pad plates 111 and 112 pressing both side surfaces of the disc D to perform braking, a caliper housing 120 provided with a piston 121 installed therein and moving forward and backward to press the pair of pad plates 111 and 112, an actuator unit including a motor 140 generating driving force and a reducer 150 connected to the motor 140, and a spindle unit 130 converting rotating force of the actuator unit into rectilinear reciprocating motion to press the piston 121.

The pair of pad plates 111 and 112 includes an inner pad plate 111 disposed adjacent to the piston 121 and an outer pad plate 112 disposed adjacent a finger part 122 which will be described later. Such a pair of pad plates 111 and 112 is installed on the carrier 110 fixed to a vehicle frame so as to move forward and backward toward or away from both side surfaces of the disc D.

A cylinder 123 in which the piston 121 is installed is provided at the rear part of the caliper housing 120, and the finger part 122 bending downward and integrally connected to the cylinder 123 to operate the outer pad plate 112 is provided at the front part of the caliper housing 120. Such a caliper housing 120 is installed on the carrier 110 so as to be slidable in the pressing direction of the pair of the pad plates 111 and 112.

The piston 121 is formed in a cylindrical shape, the inside of which is dented like a cup, and is inserted into the cylinder 123 so as to be slidable. Such a piston 121 is slid by axial force of the spindle unit 130 to which the rotating force of the motor 140 is transmitted, and presses the inner pad plate 111 toward the disc D.

The spindle unit 130 serves to press the piston 121 toward the inner pad plate 111, as described above, and is provided within the cylinder 123. Such a spindle unit 130 includes a nut member 131 provided with a female screw part 131a formed on the inner surface thereof, and a spindle member 135 provided with a male screw part 135a screw-connected to the female screw part 131a of the nut member 131.

The spindle member 135 penetrates the cylinder 123, and is rotatably provided within the cylinder 123 in parallel with the forward and backward moving direction of the nut member 131. In order to support the spindle member 135, a first bearing 125 and a second bearing 126 are installed at positions separated from each other within the cylinder 123. Here, the second bearing 126 is a thrust bearing, and accepts reaction force generated in the forward and backward moving direction of the nut member 131 during braking and transmitted through the spindle member 135. The nut member 131 is provided in a contact state with the piston 121.

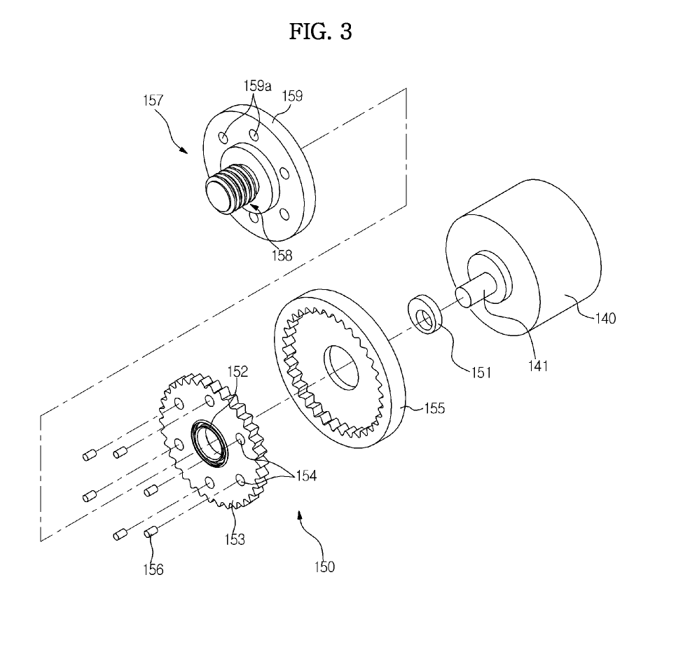

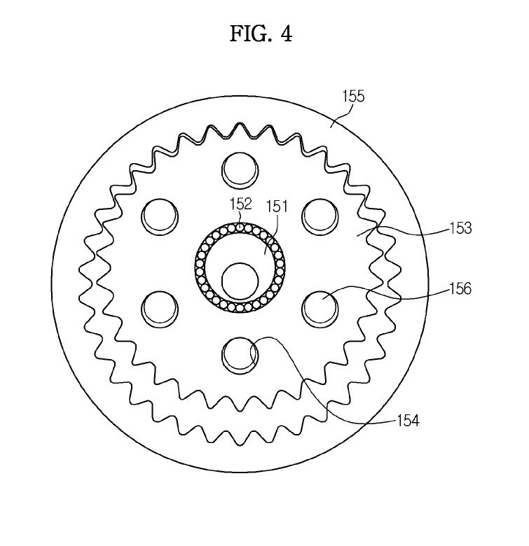

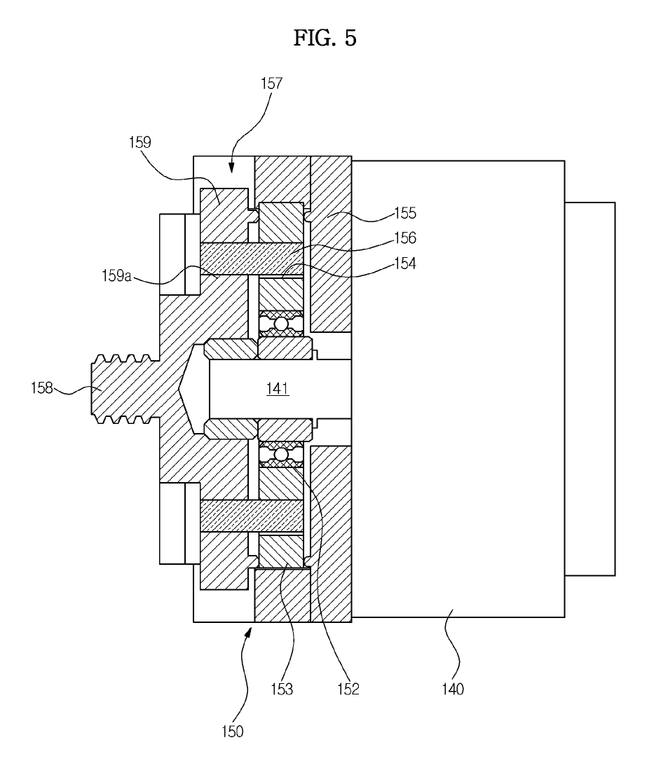

The actuator unit includes the motor 140 and the reducer 150 connected to the motor 140, as described above. FIGS. 3 to 5 illustrate such an actuator unit.

With reference to FIGS. 3 to 5, the motor 140 includes a rotary shaft 141, and generates driving force to rotate the spindle member 135 of the spindle unit 130. Here, as the motor 140, a thin (flat type) motor having a shorter axial length than a general standard motor by about 100 mm is used. This is to reduce the size of the electronic disc brake 100.

Such a motor 140 together with the reducer 150 is accommodated within a motor cover housing 145 (with reference to FIG. 2), and is installed on the rear wall of the caliper housing 120.

The motor 140 is connected to an electronic control unit (ECU; not shown) controlling the motor 140, and thus operation of the motor 140 is controlled by the ECU. For example, the ECU controls various operations of the motor 140, such as driving, stoppage, normal rotation, and reverse rotation of the motor, through input signals transmitted according to driver's instructions. If brake operating instructions or brake releasing instructions given by a driver is applied to the ECU, the ECU rotates the motor 140 in a normal direction or the reverse direction. Further, the ECU may include a count sensor to count the RPM of the motor 140 or a current sensor to sense the amount of current, and be configured so as to control the motor 140 through the RPM or the amount of current sensed by the count sensor or the current sensor. Control of the motor 140 through the ECU is well known in the art, and a detailed description thereof will thus be omitted.

The reducer 150 is connected to the rotary shaft 141 and serves to amplify driving force of the motor 140, and a cycloid reducer is used as the reducer 150 in accordance with the embodiment of the present invention. Hereinafter, the reducer 150 refers to the cycloid reducer.

The cycloid reducer 150 includes an eccentric rotator 151 connected to the rotary shaft 141 of the motor 140 and eccentrically rotated, a cycloid gear 153 eccentrically rotated by the eccentric rotator 151, an internal gear 155 engaged with the outer surface of the cycloid gear 153 and revolving and rotating the cycloid gear 153, and pins 156 respectively inserted into a plurality of through holes 154 formed on the cycloid gear 153.

A hole of the eccentric rotator 151 into which the rotary shaft 141 of the motor 140 is inserted is eccentrically formed so that the eccentric rotator 151 is eccentrically rotated.

The eccentric rotator 151 is installed at the center of the cycloid gear 153, and thus the cycloid gear 153 is eccentrically rotated. Here, the eccentric rotator 151 is connected to the cycloid gear 153 by bearings 152. That is, the bearings 152 are provided between the cycloid gear 153 and the eccentric rotator 151.

The plurality of through holes 154 is formed on the cycloid gear 153 in a radial shape from the center of the cycloid gear 153. As shown in the drawings, six through holes 154 are formed on the cycloid gear 153 at regular intervals. Here, the number of the through holes 154 may be selectively increased and decreased according to the capacity of the disc brake 1, and the pins 156 causing the cycloid gear 153 to have the same eccentricity as the eccentric rotator 151 to compensate for the eccentric center of the cycloid gear 153 are inserted into the through holes 154.

The internal gear 155 is formed in the same cycloid curve as the tooth profile of the cycloid gear 153 so as to be engaged with the outer surface of the cycloid gear 153. The internal gear 155 is fixed to the motor 140 so that the cycloid gear is revolved and rotated when the cycloid gear 153 is eccentrically rotated.

One end of the pin 156 is inserted into the through hole 154 of the cycloid gear 153, and the other end of the pin 156 is installed in an insertion hole 159a of an output shaft 157 which will be described later. That is, the output shaft 157 is connected to the cycloid gear 153 by the pins 156, thus being rotated. The output shaft 157 is a member connected to the cycloid gear 153 to transmit rotating force to the spindle member 135, and will be described in detail below.

In such a cycloid reducer 150, when the eccentric rotator 151 connected to the rotary shaft 141 of the motor 140 is rotated, the cycloid gear 153 connected to the eccentric rotator 151 by the bearings 152 is revolved within the internal gear 155 and is rotated according to a difference between the number of teeth formed on the cycloid gear 153 and the number of teeth formed on the internal gear 155.

For example, if the eccentric rotator 151 revolves the cycloid gear 153 in the clockwise direction, although the cycloid gear 153 is revolved in the clockwise direction, the cycloid gear 153 engaged with the internal gear 155 is rotated in the counterclockwise direction along the inner surface of the internal gear 155.

That is, the rate of rotation of the cycloid gear 153 is an RPM which is reduced and output, and thus reduced speed is transmitted to the spindle member 135 through the output shaft 157. Therefore, the pins 156 may be connected to the through holes 154 of the cycloid gear 153 to compensate for shaking due to revolution, and the spindle member 135 having received rotating force by the output shaft 157 connected to the spindle member 135 may be rotated collinearly with the rotary shaft 142 of the motor 140.

The output shaft 157 to transmit rotating force of the cycloid reducer 150 to the spindle member 135 includes a shaft part 158 connected to the spindle member 135, and a flange part 159 protruded from the shaft part 158 in the radial direction. Insertion holes 159a are formed on the flange part 159 at positions corresponding to the through holes 154. That is, the pins 156 are connected to the insertion holes 159a. Thereby, the pins 156 cause rotating force transmitted from the cycloid gear 153 to synchronize with revolution of the cycloid gear 153 so that the output shaft 157 may be rotated collinearly with the rotary shaft 141 of the motor 140, and the output shaft 157 transmits rotating force to the spindle member 135 collinearly connected to the output shaft 157 so that the spindle member 135 may be rotated collinearly with the rotary shaft 141 of the motor 140.

The electronic disc brake 100 in accordance with this embodiment of the present invention employing the above-described structure of the cycloid reducer 150 greatly increases a contact ratio between gears as compared to combination of conventional spur gears and may thus obtain higher output torque, and has a reduced thickness as compared to a gear assembly of planet gears and may thus reduce the total length of the actuator.

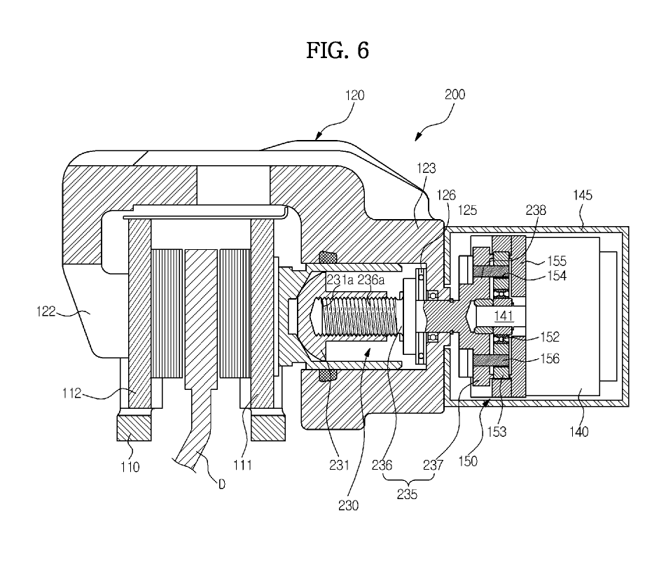

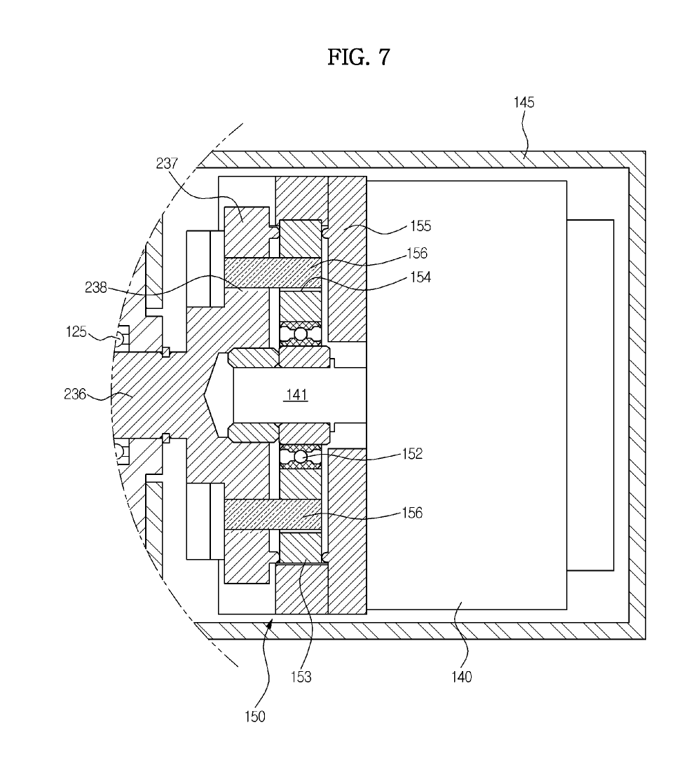

Although this embodiment illustrates connection of the cycloid reducer 150 and the spindle member 135 by the output shaft 157, embodiments of the present invention are not limited thereto and the spindle member 135 may be connected directly to the cycloid reducer 150. For example, as shown in FIGS. 6 and 7, an electronic disc brake 200 in accordance with another embodiment of the present invention includes a spindle unit 230 including a nut member 231 and a spindle member 235 connected directly to the cycloid reducer 150. Here, the spindle member 235 includes a spindle shaft 236 provided with a male screw part 236a formed on the outer circumferential surface thereof and a flange part 237 protruded from the end of the spindle shaft 236 in the radial direction. Insertion holes 238 are formed on the flange part 237 at positions corresponding to the through holes 154 formed on the cycloid gear 153. That is, the spindle shaft 236 of the spindle member 235 is screw-connected to a female screw part 231a formed on the inner circumferential surface of the nut member 231, and the flange part 237 is provided at the outside of the rear wall of the caliper housing 120 and is connected with the pins 156 of the reducer 150.

More specifically, the other end of each of the pin 156 is connected to each of the insertion holes 238 formed on the flange part 257. Thereby, as described above, the pins 156 cause rotating force transmitted from the cycloid gear 153 to synchronize with revolution of the cycloid gear 153, and thus the spindle member 235 may be rotated collinearly with the rotary shaft 141 of the motor 140.

Hereinafter, braking operation of the above-described electronic disc brake will be described.

First, when a driver of a vehicle presses a control device (not shown), for example, a parking switch (not shown) under the condition that the two pad plates 111 and 112 are separated from both sides of the disc D (braking is released), the motor 140 is rotated to generate driving force according to a signal from the control device. That is, the cycloid reducer 150 having received rotating force by the rotary shaft 141 of the motor 140 is eccentrically rotated to achieve speed reduction, and then the output shaft 157 connected to the cycloid reducer 150 transmits the rotating force to the spindle member 135. Here, the spindle member 235 may be connected directly to the cycloid reducer 150 to receive the rotating force. That is, the spindle member 135 or 235 amplifies torque of the motor 140 as much as a reduction ratio of the cycloid gear 153, and thus generates output. Therefore, when the nut member 131 or 231 forwardly and backwardly movably connected to the spindle member 135 or 235 moves and presses the piston 121, the piston 121 pushes the inner pad plate 111 toward the disc D, and the caliper housing 120 slides and press the outer pad plate 112 toward the disc D, thereby performing braking operation.

On the other hand, when braking force is released, the spindle member 135 or 235 is rotated in the opposite direction to the direction during braking, the nut member 131 or 231 moves to its original position and the two pad plates 111 and 112 are separated from both sides of the disc D and are restored to their original positions.

Consequently, a structure of transmitting driving force of the motor 140 to the spindle member 135 or 235 under the condition that the driving force is amplified by the cycloid reducer 150 is connected in a serial manner, and thus the total size of the electronic disc brake may be reduced as compared to the conventional electronic disc brake. Therefore, the electronic disc brake has a reduced weight, is easy to install, improves utilization of a space for installation of the electronic disc brake, and may thus be easily installed regardless of vehicle size. Further, the electronic brake disc may minimize braking noise generated during braking by means of a serial type gear assembly structure.

As is apparent from the above description, an electronic disc brake uses a cycloid reducer, connects a spindle member directly to the cycloid reducer in series, and uses a thin motor as a motor of an actuator generating braking force, thus minimizing the total length. Thereby, the electronic disc brake may provide a compact connection structure and improve space utilization, thus being installed regardless of vehicle capacity. That is, the electronic disc brake may reduce the sizes (volumes) of unnecessary cylinder and carrier and may thus have a reduced weight.

Further, the electronic disc brake may achieve high speed reduction through the cycloid reducer, minimize the length of the cycloid reducer, and greatly reduce operating noise during braking as compared to a conventional multiple stage gear assembly.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic disc brake which has a carrier fixed to a frame of a vehicle, a caliper housing installed on the carrier so as to be slidable, a pair of pad plates installed within the carrier so as to be forwardly and backwardly movable and disposed at both sides of a disc rotating together with a wheel of the vehicle, and a piston installed within a cylinder part provided on the caliper housing so as to be forwardly and backwardly movable and pressing one of the pair of pad plates toward the disc, the electronic disc brake comprising:
a spindle member passing through the rear wall of the caliper housing and rotated within the cylinder part;
a nut member screw-connected to the spindle member and moving forward and backward according to rotation of the spindle member to press the piston or to release pressing of the piston;
a motor installed on the outer surface of the caliper housing and generating driving force to rotate the spindle member; and
a cycloid reducer amplifying the driving force generated from the motor and transmitting the amplified driving force to the spindle member,
wherein the motor, the cycloid reducer and the spindle member are coaxially connected in series.

2. The electronic disc brake according to claim 1, wherein the motor is a thin motor.

3. The electronic disc brake according to claim 1, wherein the motor and the cycloid reducer are accommodated in a motor cover housing and are installed on the rear wall of the caliper housing.

4. The electronic disc brake according to claim 1, wherein the cycloid reducer includes:
an eccentric rotator connected to a rotary shaft of the motor and eccentrically transmitting rotation of the motor;
a cycloid gear provided with a plurality of through holes disposed in a radial direction from the center thereof and eccentrically rotated by the eccentric rotator, the eccentric rotator being installed at the center of the cycloid gear;
an internal gear engaged with the outer surface of the cycloid gear and revolving and rotating the cycloid gear by rotation of the rotary shaft; and
pins respectively inserted into the plurality of through holes and compensating for the eccentric center of the cycloid gear.

5. The electronic disc brake according to claim 4, wherein the internal gear is fixed to the motor so as not to be rotated.

6. The electronic disc brake according to claim 4, wherein bearings are installed between the cycloid gear and the eccentric rotator.

7. The electronic disc brake according to claim 4, further comprising an output shaft connected with the pins and transmitting rotating force to the spindle member, wherein the output shaft includes:
a shaft part screw-connected to the spindle member having passed through the rear wall of the caliper housing; and
a flange part protruded from the end of the shaft in the radial direction; and
insertion holes are formed on the flange part at positions corresponding to the plurality of through holes, and connected with the pins.

8. The electronic disc brake according to claim 4, wherein the spindle member includes:
a spindle shaft having a designated length and provided with a male screw part screw-connected to the nut member and formed on the outer circumferential surface of one end of the spindle shaft; and
a flange part protruded from the other end of the spindle shaft in the radial direction; and
insertion holes are formed on the flange part at positions corresponding to the plurality of through holes, and connected with the pins.
